(19) United States
(12) Patent Application Publication
(10) Pub. No.: US 2022/0253405 A1
(43) Pub. Date: Aug. 11, 2022

(54) FILE SYSTEM

(71) Applicant: SHANGHAI BINLI TECHNOLOGY CO., LTD., Shanghai (CN)

(72) Inventor: Wenyun Niu, Shanghai (CN)

(21) Appl. No.: 17/732,373

(22) Filed: Apr. 28, 2022

Related U.S. Application Data
(63) Continuation of application No. PCT/CN2020/106798, filed on Aug. 4, 2020.

(30) Foreign Application Priority Data
Oct. 29, 2019 (CN) 201911038055.0

(51) Int. Cl. G06F 16/16; G06F 16/14; G06F 16/17

(52) U.S. Cl. CPC G06F 16/164; G06F 16/1734; G06F 16/148

(57) ABSTRACT

A file system being applied to a file library without a directory structure includes a file name correspondence module configured to establish the correspondence between a file name and the FCB of a file; a tag assignment module configured to establish, according to a tag assignment instruction, the correspondence between a tag, which is in a tag library pre-storing at least one tag and corresponds to the tag assignment instruction, and the FCB of a file corresponding to the tag assignment instruction; and a retrieval module configured to receive a retrieval instruction, find, according to the retrieval instruction, a target file corresponding to the retrieval instruction by using at least one of the correspondence between the FCB of the file and the file name or the correspondence between the FCB of the file and the tag, and open and/or display the target file.

### CROSS-REFERENCE TO RELATED APPLICATION(S)

This is continuation of International Patent Application No. PCT/CN2020/106798, filed on Aug. 4, 2020, which is based on and claims priority to Chinese Patent Application No. 201911038055.0, entitled “FILE SYSTEM” and filed with the China National Intellectual Property Administration (CNIPA) on Oct. 29, 2019, the disclosure of which is incorporated herein by reference in its entirety.

### TECHNICAL FIELD

The present application relates to a computer field and, in particular, to a file system.

### BACKGROUND

Current operating systems, such as Windows, Unix, Linux and Mac OS, and various derived operating systems of intelligent devices organize file systems in the form of directory structures. Files are stored in the form of multi-level directories structure (which is also referred to as a tree structure and includes a root directory and multi-level subdirectories). A file storing multiple levels of directories is referred to as a directory file. A file control block (FCB) used in Windows stores a file attribute including the address information of where a file starts in the memory area. The FCB used in Windows is decomposed into a directory entry and an Mode in Unix and Linux. The directory entry includes a file name and a pointer pointing to the Mode.

In the related art, two steps are required for accessing one file. First, directory retrieval is required. In Windows, after receiving a multi-level directory entry which is a path containing a file name, the system retrieves the directory entry level by level until the FCB of the target file is found in the end-level directory. In Unix and Linux, the first Mode is found from the first level of a multi-level directory entry which is a path containing the file name, then following Modes are retrieved one by one from following levels of the entry until the physical address of the target file is found in the last Mode. Such a directory entry decomposition method (which also referred to as an FCB decomposition method) stores the file attribute in the Mode, thereby reducing the information amount of the directory entry and speeding up a retrieval speed to a certain degree. Finally, the file is addressed according to the physical address.

However, in the related art, it is necessary to start from a root directory so that a file can be found, costing plenty of time. A user can use the file name to search for the file. However, if the file name is relatively long and the user cannot remember the file name, then the user needs to remember all directory entries (the root directory and the multi-level subdirectories) of the file so as to find the target file, bringing great memory burden to the user and lowering the efficiency of file retrieval.

Accordingly, an efficient file system is required.

### SUMMARY

In this regard, an object of embodiments of the present application is to provide an efficient file system. The specific solution is described below.

A file system is provided. The file system is applied to a file library without a directory structure. The file system includes a file name correspondence module, a tag assignment module, and a retrieval module.

The file name correspondence module is configured to establish the correspondence between the file name of a file and the file control block (FCB) of the file and store the file name and the correspondence between the file name and the FCB of the file in an information table. The information table includes at least one row of information. Each row of information represents the descriptive information of one file.

The tag assignment module is configured to establish, according to a tag assignment instruction, the correspondence between a tag, which is in a tag library and corresponds to the tag assignment instruction, and the FCB of the file corresponding to the tag assignment instruction, and store the tag and the correspondence between the tag and the FCB of the file in the information table. The file system includes the tag library, and the tag library pre-stores at least one tag.

The retrieval module is configured to receive a retrieval instruction; find, according to the retrieval instruction, a target file corresponding to the retrieval instruction in the information table and the file library by using at least one of the correspondence between the file name and the FCB of the file or the correspondence between the tag and the FCB of the file; and open and/or display the target file.

The retrieval instruction includes at least one of the file name of the target file or the tag corresponding to the target file.

Optionally, the file name correspondence module establishes the correspondence between the file name of a file and the FCB of the file in one of the following manners: including the file name of the file in the FCB of the file, or establishing a mapping relationship between the file name of the file and the FCB of the file.

Optionally, the tag assignment module establishes the correspondence between the tag corresponding to the file and the FCB of the file in one of the following manners: including the tag in the FCB of the file, or establishing a mapping relationship between the tag and the FCB of the file.

Optionally, in the case where the FCB of a file includes the file name of the file and the tag corresponding to the file, each row in the information table represents the FCB of the file. The FCB of the file includes the file name of the file, the tag, and the physical address of the file.

Optionally, in the case where the mapping relationship between the file name of a file and the FCB of the file exists and the mapping relationship between the tag corresponding to the file and the FCB of the file exists, each row in the information table comprises the FCB of the file, the file name of the file, and the tag.

Optionally, the tag assignment module establishes the correspondence between the tag corresponding to the file and the FCB of the file by performing the operations below.

According to the tag assignment instruction, it is queried in the tag library in the file system whether the tag corresponding to the tag assignment instruction exists.

In the case where the tag corresponding to the tag assignment instruction exists in the tag library, It is checked in the information table whether the combination of the file name and the tag already exists.

In the case where it is checked in the information table that the combination of the file name and the tag does not exist, the correspondence between the tag corresponding to the tag assignment instruction and the FCB of the file corresponding to the tag assignment instruction is established, and the correspondence and the combination of the file name and the tag is stored in the information table.

Optionally, in the case where no tag corresponding to the tag assignment instruction exists in the tag library, a tag is newly added in the tag library, the correspondence between the newly-added tag and the FCB of the file corresponding to the tag assignment instruction is established, and the correspondence and the combination of the tag and the file name are stored in the information table.

Optionally, in the case where it is checked that the combination of the file name and the tag already exists in the information table, at least one of the file name or the tag is prompted to be changed until the combination of the file name and the tag does not exist.

Optionally, the file system further includes a file name library configured to store file names. Alternatively, a file name is taken as a special tag to be stored in the tag library.

Optionally, the tag assignment module is specifically configured to establish, according to the tag assignment instruction, the correspondence between the file name of the file and the tag which is in the tag library and corresponds to the tag assignment instruction.

Optionally, the tag library further stores at least one tag number. The at least one tag has one-to-one correspondence with the at least one tag number. The tag assignment module is further configured to establish, according to the tag assignment instruction, the correspondence between the tag number of the tag, which is in the tag library and corresponds to the tag assignment instruction, and the file name of the file; and store the tag number and the correspondence between the tag number and the file name of the file in the information table.

The retrieval module is further configured to receive the retrieval instruction; find, according to the retrieval instruction, the target file corresponding to the retrieval instruction by using at least one of the tag number, the correspondence between the file name and the FCB of the file, or the correspondence between the tag and the FCB of the file; and open and/or display the target file.

Optionally, the file system further includes an association number generation module. The association number generation module is configured to generate an association number and establish the correspondence between a tag set and the association number. The tag set includes one or more tags corresponding to the file. The file system further includes an association number library which is configured to store the association number and the correspondence between the tag set and the association number. Further, the association number and the correspondence between the tag set and the association number is applied to the file in the information table.

The retrieval module is further configured to receive the retrieval instruction and open and/or display, according to the retrieval instruction, the target file corresponding to the retrieval instruction by using at least one of the association number, the correspondence between the file name and the FCB of the file, or the correspondence between the tag and the FCB of the file.

Optionally, the association number generation module includes a tag quantity determination unit, an association number determination unit, and an association number generation unit.

The tag quantity determination unit is configured to determine whether the quantity of tags corresponding to a file meets a quantity requirement.

The association number determination unit is configured to, in the case where the tag quantity determination unit determines that the quantity of tags corresponding to the file meets a quantity requirement, determine whether the tag set selected from the plurality of tags corresponding to the file according to a preset tag selection rule has a corresponding association number.

The association number generation unit is configured to, in the case where the association number determination unit determines that the tag set has no corresponding association number, newly generate an association number, establish the correspondence between the tag set and the newly-generated association number, store the association number and the correspondence between the tag set and the newly-generated association number in the association number library, and apply the association number and the correspondence between the tag set and the newly-generated association number to the information table.

Optionally, the file system further includes a file number generation module. The file number generation module is configured to generate a file number, establish the correspondence between the file number and the FCB of a file, and store the file number and the correspondence between the file number and the FCB of the file in the information table. The file system further includes a file number library. The file number library is configured to store file numbers.

The retrieval module is further configured to receive the retrieval instruction; find, according to the retrieval instruction, the target file corresponding to the retrieval instruction by using at least one of the file number, the correspondence between the file name and the FCB of the file, or the correspondence between the tag and the FCB of the file.

Optionally, the file number generation module is further configured to establish the correspondence between the file number and the file name of the file.

Optionally, the file system further includes an attribute setting module. The attribute setting module is configured to establish at least one of a correspondence between a preset attribute and the association number or a correspondence between a preset attribute and the tag.

Optionally, the file system further includes an association number generation module and an attribute setting module.

The association number generation module is configured to generate an association number and establish a correspondence between a tag set and the association number, wherein the tag set comprises one or more tags corresponding to the file.

The attribute setting module is configured to establish at least one of a correspondence between a preset attribute and the association number or a correspondence between a preset attribute and the tag.

Optionally, the attribute setting module includes an access right setting unit. The access right setting unit is configured to establish at least one of a correspondence between a preset access right and the association number or a correspondence between a preset access right and the tag.

Optionally, the attribute setting module includes a priority setting unit. The priority setting unit is configured to set at least one of a priority of the association number or a priority of the tag.

The retrieval module is further configured to receive the retrieval instruction; find, according to the retrieval instruction, the target file corresponding to the retrieval instruction by using at least one of the correspondence between the FCB of the file and the file name or the correspondence between the FCB of the file and the tag; and display the target file in sequence by using at least one of the priority of an association number or the priority of the tag.

In embodiments of the present application, the file system is applied to the file library without the directory structure. The file system includes the file name correspondence module, the tag assignment module, and the retrieval module. The file name correspondence module is configured to establish the correspondence between the file name and the FCB of the file. The tag assignment module is configured to establish, according to the tag assignment instruction, the correspondence between the tag corresponding to the tag assignment instruction in the tag library, which pre-stores at least one tag, and the FCB of the file corresponding to the tag assignment instruction. The retrieval module is configured to receive a retrieval instruction; find, according to the retrieval instruction, a target file corresponding to the retrieval instruction by using at least one of the correspondence between the file name and the FCB of the file or the correspondence between the tag and the FCB of the file; and open and/or display the target file.

The retrieval instruction includes at least one of the file name of the target file or the tag corresponding to the target file.

In embodiments of the present application, the correspondence between the FCB of the file and the file name and the correspondence between the FCB of the file and the tag are established for the file so that the file can be found rapidly through at least one of the file name or the tag, no longer needing to index a multi-level directory structure, implementing a flat management for the file, and improving the efficiency of file retrieval and addressing.

### BRIEF DESCRIPTION OF DRAWINGS

To illustrate the technical solutions in embodiments of the present application or the solutions in the related art more clearly, drawings used in the description of the embodiments or the related art are briefly described hereinafter. Apparently, the drawings described hereinafter are merely embodiments of the present application, and those skilled in the art may obtain other drawings based on provided drawings on the premise that no creative work is done.

FIG. 1 is a diagram illustrating the structure of a file system according to embodiments of the present application.

FIG. 2 is a diagram illustrating the structure of another file system according to embodiments of the present application.

FIG. 3 is a diagram illustrating the structure of another file system according to embodiments of the present application.

FIG. 4 is a diagram illustrating the structure of another file system according to embodiments of the present application.

### DETAILED DESCRIPTION

The technical solutions in embodiments of the present application will be described clearly and completely in conjunction with the drawings in embodiments of the present application. Apparently, the embodiments described hereinafter are part, not all, of embodiments of the present application. Based on embodiments of the present application, all other embodiments obtained by those of ordinary skill in the art without creative work are within the scope of embodiments of the present application.

As used in the present application and in the claims, a list of items joined by the term “and/or” can mean any combination of the listed items. For example, the phrase “A and/or B” can mean A, B, or A and B. As used in this application and in the claims, a list of items joined by the term “at least one of” can mean any combination of the listed terms. For example, the phrases “at least one of A, or B” can mean A, B or A and B.

In a current operating system, files are stored in the form of a file directory in the operating system to facilitate the storage and retrieval of plenty of files in a computer. The file directory refers to a file composed of a directory structure. Directory structures include single-level directory structures, two-level directory structures, and multi-level directory structures. A single-level directory structure is not suitable for a multi-user operating system. A two-level directory structure cannot classify different files. As the most commonly used directory structure, a multi-level directory structure is also referred to as a tree directory structure. The multi-level directory structure includes a root directory and multi-level subdirectories. Generally, the multi-level directory structure is stored in an external memory of a computer.

A file directory is a file with a special structure and includes multiple file control blocks (FCBs) in a certain sequence. Generally, one FCB can be referred to as one directory entry. In the multi-level directory structure, the root directory may include one or more FCBs. Each subdirectory may also include one or more FCBs. Each FCB includes a file name and a physical address.

It should be noted that although the FCB used in Windows is decomposed into a directory entry and an inode in Unix and Linux, the file system in Unix and Linux is still in the multi-level directory structure. The directory entry in Unix and Linux includes a file name and a pointer pointing to the first-level inode which includes a subdirectory entry. The system in Unix and Linux finds a pointer pointing to a second-level inode from the subdirectory entry and goes to the second-level inode. The number of the multi-level inodes depends on the number of the levels of directories of a file path containing the file name. The physical address of the file can be obtained only from the last-level inode. For this reason, the FCB in Windows is equivalent to the last-level inode in Unix and Linux regarding the physical address of a file. The description of the embodiments of the present application will generally focus on FCB and can be easily applied to the inode in Unix and Linux.

In the multi-level directory structure, files under the same directory cannot have the same file name. When a file is created and saved, the system checks whether a file name input by a user already exists and prompts the user to modify the file name if the file name already exists.

From the perspective of file management, one file usually includes two parts, a file description and a file body. The file body refers to the content of the file and is usually stored in a file library of the system. The file description of the file refers to the FCB of the file. The file body of the file can be found through a physical address in the FCB. The FCB of the file may further include information such as file modification time, file type, and file size.

When an electronic device such as a computer boots up, the computer system of the electronic device reads a root directory stored in an external memory into an internal memory by default. The user can use an absolute path or a relative path to achieve file retrieval, the absolute path refers to a path starting from the root directory, and the relative path refers to a path starting from the current directory (for example, a first-level subdirectory).

If the user inputs the absolute path to retrieve the file, the computer operating system determines, in the root directory, the physical address of the first-level subdirectory corresponding to the absolute path, reads the first-level subdirectory from the external memory of the computer into the internal memory according to the physical address of the first-level subdirectory, and reads other levels of subdirectories corresponding to the absolute address into the internal memory of the computer in sequence until the physical address of the target file is found. Then the system uses the physical address to find the target file, and the target file is read from the external memory into the internal memory. Because the operation of disk I/O reading is performed multiple times in the preceding operation, the efficiency of file retrieval by use of a file directory system is very low. If the user wants to use the relative address to retrieve the file, the user needs to clearly memorize all levels of directories. It is undoubtedly difficult to achieve in the case of plenty of files.

To improve the efficiency of file retrieval, embodiments of the present application provide a file system. For a current operating system, especially for a multi-user operating system, files are no longer stored in the form of a multi-level directory structure.

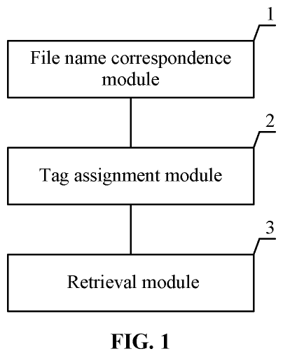

The file system disclosed in embodiments of the present application can be applied to a file library without a directory structure. Referring to FIG. 1, the system includes a file name correspondence module 1, a tag assignment module 2, and a retrieval module 3.

The file name correspondence module 1 is configured to establish the correspondence between a file name and the FCB of a file and store the file name and the correspondence between the file name and the FCB of the file in the information table.

With an aim of implementing a uniform management and the flat management for the file and canceling the method of using directories for file management, the concept of a file storage directory and the concept of a file path no longer exist when files are stored using the file system provided in embodiments of the present application, implementing the flat management for the file.

In embodiments of the present application, the file body of one file is stored in the file library, and the file description of the file is stored in the information table. The file library is stored in an external memory of a computer. In performing file retrieval, the system first determines the physical address of a target file according to the information table, then finds the target file from the file library in the external memory according to the physical address, and finally reads the target file into an internal memory.

The file system of the present application includes the information table and a file name library. The file name library is configured to store file names of different files. The information table includes at least one row of information. Each row of information represents the descriptive information of one file.

The file name library and the information table are stored in the external memory of the computer. When the computer boots up, the system reads the information table from the external memory into the internal memory by default. In performing file retrieval, the system uses only the information table and does not need to use the file name library; accordingly, the file name library does not need to be read from the external memory into the internal memory. The system reads the file name library from the external memory into the internal memory only when receiving a user's request for such tasks as querying, searching for, displaying, newly adding, modifying, or deleting the file name in the file name library. The modified information table and the file name library in the internal memory are written back to the external memory in time.

Exemplarily, the FCB of the file can be found through the file name of the file. Before the file name is used for finding the FCB of the file, the correspondence between the file name and the FCB of the file is established. The correspondence includes direct correspondence and indirect correspondence. The direct correspondence refers to that the correspondence is established between the file name and the FCB directly. The indirect correspondence refers to that the correspondence is established between the file name and the FCB of the file through other information.

As for a first file (a newly created file), the process of establishing the correspondence between a file name and an FCB of the first file may include steps 1 to 3.

In step 1, the system receives a file creation instruction that is input through a corresponding input interface by the user or another application.

The file creation instruction includes a file name for the first file.

In step 2, the system creates the first file according to the file creation instruction. The first file includes the file body of the first file and the FCB of the first file.

In step 3, the system names the first file by using the file name included in the file creation instruction, establishes the correspondence between the file name and the FCB of the first file, and stores the file name and the correspondence between the file name and the FCB of the first file in the information table.

Optionally, a manner for establishing the correspondence between the file name and the FCB of the first file includes storing the file name in the FCB of the file or establishing the correspondence between the file name and the FCB of the file through mapping.

Optionally, the correspondence between the file name and the FCB of the file includes direct correspondence and indirect correspondence. The above-established correspondence between the file name and the FCB is direct correspondence. The indirect correspondence between the file name and the FCB of the file refers to that the indirect correspondence between the file name and the FCB is established through other intermediate information. For example, one file number is established for the file name, and the indirect correspondence between the file name and the FCB of the file is implemented through the file number.

As for a second file (a file that has been established but is not stored in the file library), the process of establishing the correspondence between a file name and an FCB of a second file may include steps 1 to 3.

In step 1, the system receives a file movement instruction input by the user.

The file movement instruction includes a target file name.

In step 2, the system moves the second file to the file library according to the file movement instruction and newly generates an FCB of the second file in the file library based on the original FCB of the second file.

The second file in the file library includes a file body and the new FCB which includes a physical address of the second file in the file library.

In step 3, according to the file movement instruction, the system establishes the correspondence between the target file name and the new FCB of the second file, and stores the target file name and the correspondence between the target file name and the new FCB of the second file in the information table.

Optionally, a manner for establishing the correspondence between the target file name and the FCB of the second file includes storing the target file name in the new FCB of the second file or establishing the correspondence between the target file name and the new FCB of the second file through mapping.

Optionally, the correspondence between the target file name and the new FCB of the second file includes direct correspondence and indirect correspondence. The above-established correspondence between the target file name and the new FCB of the second file is direct correspondence. The indirect correspondence between the target file name and the new FCB of the second file refers to that the indirect correspondence between the target file name and the new FCB of the second file is established through other intermediate information. For example, one file number is established for the target file name, and the indirect correspondence between the target file name and the new FCB of the second file is implemented through the file number.

The tag assignment module 2 is configured to establish, according to a tag assignment instruction, the correspondence between a tag, which is in a tag library and corresponds to the tag assignment instruction, and the FCB of the file corresponding to the tag assignment instruction, and store the tag and the correspondence between the tag and the FCB of the file in the information table, where the tag library pre-stores at least one tag.

With an aim of meeting the user's personalized requirements for the file and further improving the efficiency of file indexing, after the correspondence between the file name and the FCB of the file is established, the correspondence between the tag and the FCB of the file can also be established.

The at least one tag in the tag library may be pre-stored by the user. When the tag that the user wants to assign is not in the tag library, the user can newly add a tag to the tag library.

The tag assignment instruction input by the user includes the required tag and the file to which the tag is to be assigned. According to the required tag, the system determines whether the required tag exists in the tag library. If the required tag exists in the tag library, the system assigns the required tag in the tag library to the file to which the tag is to be assigned, thus establishing the correspondence between the tag and the FCB of the file. If the required tag does not exist in the tag library, the system prompts the user to newly add a tag or newly adds the required tag automatically to the tag library and assigns the newly-added tag to the file to which the tag is to be assigned, thus establishing the correspondence between the tag and the FCB of the file; accordingly, the tag assignment of the file is completed.

The file system in embodiments of the present application includes the tag library. The tag library is configured to store tags corresponding to different files. The tag library is stored in the external memory of the computer. In performing file retrieval, the system uses only the information table and does not need to use the tag library; accordingly, the tag library does not need to be read from the external memory into the internal memory. The system reads the tag library from the external memory into the internal memory only when receiving the user's request for such tasks as querying, searching for, displaying, newly adding, modifying, or deleting the tag in the tag library. The modified tag library in the internal memory is written back to the external memory in time.

In particular, when a tag column exists in the information table, the content area of the tag column can be regarded as a place to store tags, so this area can be considered as a tag library thus there is no need for having a stand-alone tag library any more. However, a tag library can be generated from the content of the tag column if needed, with duplicated tags removed if needed. It should be noted that all tags in the information table must be in the tag library.

Optionally, a manner for establishing the correspondence between the tag and the FCB of the file includes storing the tag in the FCB of the file or establishing the correspondence between the tag and the FCB of the file through mapping.

A file name is also a tag in essence. In a practical application, the file system in embodiments of the application may not include the file name library. A file name may also be stored in the tag library in the form of a special tag.

Optionally, the correspondence between the tag and the FCB of the file includes direct correspondence and indirect correspondence. The above-established correspondence between the tag and the FCB is direct correspondence. The indirect correspondence between the tag and the FCB of the file refers to that the indirect correspondence between the tag and the FCB of the file is established through other intermediate information. For example, an association number is established for multiple tags, and the correspondence between the tag and the FCB of the file is implemented through the association number.

In the preceding solution, the file name and the FCB of the file are in direct correspondence, and the tag and the FCB of the file are also in direct correspondence. Accordingly, the file name or the tag can be used for retrieving the file. However, when the file name or the tag is used for retrieving the file, the retrieval result may be not unique. To implement precise retrieval, the user can search for the file through a combination of the file name and the tag.

Additionally, the correspondence between the file name and the tag may be established to diversify retrieval manners. For example, the file name directly corresponds to the FCB of the file, and the tag directly corresponds to the file name; accordingly, the indirect correspondence between the tag and the FCB of the file is implemented. When the tag is used for searching for the file, the file name corresponding to the tag is found first. Then the corresponding file is found using the correspondence between the file name and the FCB of the file. Accordingly, the manner in which the file is found using the tag is implemented.

It is to be noted that an area storing tags which corresponds to an untagged file is null, which can also be used as an attribute to mark the untagged file. The untagged file can also be searched for through a retrieval instruction corresponding to the attribute of no tag.

In the file system of the present application, the tags and the tag library are newly added. When the user creates and saves a file, the system no longer checks whether a file name input by the user already exists but checks whether a combination of the file name and the tag already exists. If the combination does not exist, the file is saved. Accordingly, files are allowed to have the same name in the file system of the present application. Exemplarily, the correspondence between the file name and the FCB of the file is that the FCB of the file includes the file name, and the correspondence between the tag and the FCB of the file is that the FCB of the file includes the tag. In this case, each row of information in the information table represents the FCB of the file. Each FCB includes the file name, the tag and physical address of the file. Additionally, the FCB of the file may further include information that is usually displayed in a file management interface, such as file modification time, file type, and file size.

Each row of information in the information table may be stored separately as one file. Alternatively, the information table may be stored as one file. The information table is equivalent to the root directory in a multi-level directory structure in the related art. The root directory includes one or more FCBs. The information table also includes one or more FCBs.

For example, in the case where the correspondence between the file name and the FCB of the file and the correspondence between the tag and the FCB of the file are that the FCB of the file includes the file name and the tag, part of the information in the information table generated by the system is shown in Table 1. In Table 1, each row represents the FCB of one file. The FCB of each file includes a file name, at least one tag, and a physical address. It is to be noted that information including file modification time, file type, and file size is not listed in the information table of Table 1.

It can be seen from Table 1 that two files having the same name, p1B, are allowed to exist in the file system in embodiments of the present application. Because the two files have different tags, file retrieval can be performed through one or more tags or a combination of the file name and the one or more tags even if the file name is the same.

TABLE 1

| | | Physical |
|---|---|---|
| File Name | Tag | Address |
| Cell1 | Project 1, engineering, | 4 |
| | software, SW | |
| Cell2 | Project 1, engineering, | 5 |
| | software, SW | |
| Af1 | Project 1, engineering, | 6 |
| | software, APP | |
| Af2 | Project 1, engineering, | 7 |
| | software, APP | |
| fw1 | Project 1, engineering, | 8 |
| | software, FW | |
| fw2 | Project 1, engineering, | 9 |
| | software, FW | |
| fw3 | Project 1, engineering, | 10 |
| | software, FW | |
| p1B | Project 1, engineering, | 11 |
| | hardware, material list | |
| p1B | Project 1, production, | 12 |
| | material list | |
| Plan 1 | Project 1, management, plan | 13 |
| Cost 1 | Project 1, management, cost | 14 |
| s | Project 1, engineering, | 15 |
| | hardware, PCB design, | |
| | circuit diagram | |
| p | Project 1, engineering, | 16 |
| | hardware, PCB design, layout | |
| Test report | Project 1, engineering, | 17 |
| | hardware, test | |

The retrieval module 3 is configured to receive a retrieval instruction, find a target file corresponding to the retrieval instruction by using the retrieval instruction and at least one of the correspondence between the file name and the FCB of the file or the correspondence between the tag and the FCB of the file, and open and/or display the target file.

In performing file retrieval, the retrieval module receives the retrieval instruction from the user and retrieves the target file corresponding to the retrieval instruction by using the retrieval instruction and the correspondence between the FCB of the file and the file name or the correspondence between the FCB of the file and the tag. The retrieval instruction includes at least one of the file name of the target file or the tag corresponding to the target file. The retrieval instruction may be at least one of the file name corresponding to the target file or the tag corresponding to the target file. For example, the retrieval instruction includes the file name corresponding to the target file. Alternatively, the retrieval instruction includes the tag corresponding to the target file. Alternatively, the retrieval instruction includes the file name corresponding to the target file and the tag corresponding to the target file. On this basis, the target file can be found rapidly through the retrieval instruction.

The retrieval instruction may further include at least one of a file opening instruction or a file display instruction. When the retrieval instruction includes only the file opening instruction, after finding the target file, the system directly opens the file according to the instruction but does not need to display the file in the file management interface. When the retrieval instruction includes only the file display instruction, after finding the target file, the system displays the file in the file management interface but does not directly open the file. When the retrieval instruction includes both the file opening instruction and the file display instruction, after finding the target file, the system displays the file in the file management interface and opens the file according to the instructions.

When an electronic device such as the computer boots up, the computer system of the electronic device reads the information table stored in the external memory of the computer into the internal memory of the computer by default. When retrieving the target file, the physical address of the target file may be retrieved by querying the information table once according to at least one of the file name or the tag input by the user, and the target file can be found directly according to the physical address.

It is to be noted that when the content included in the retrieval instruction is different, the quantity of target files found using the retrieval instruction is also different. When the retrieval instruction includes a file name or tag corresponding to a target file, multiple target files satisfying the retrieval instructions can be found using the retrieval instruction, implementing rough target-file retrieval. When the user wants to implement file retrieval precisely, the retrieval instruction may include a file name and tag corresponding to a target file. That is, more retrieval conditions indicate a more precise retrieval result.

For example, when the retrieval instruction includes a tag “engineering”, the system determines, according to the instruction, FCBs of files corresponding to the tag “engineering”, determines physical addresses of the files according to the FCBs of the files, and finds the target files through the physical addresses.

The retrieval result is displayed in the file management interface as shown in Table 2. The interface includes eleven files corresponding to the tag “engineering”. The eleven files are arranged in the form of a list. The display result includes the tag, file name, modification date, type and size of each file. Additionally, other information of each file can be displayed according to the requirements of the user.

TABLE 2

| | File | Modification | | | |
|---|---|---|---|---|---|
| Tag | Name | Date | Type | Size | |
| Project 1, engineering, | Cell1 | Mar. 4, 2018 | .doc | 84 | KB |
| software, SW | | | | | |
| Project 1, engineering, | Cell2 | Mar. 5, 2018 | .doc | 116 | KB |
| software, SW | | | | | |
| Project 1, engineering, | Af1 | Mar. 4, 2018 | .jpg | 194 | KB |
| software, APP | | | | | |
| Project 1, engineering, | Af2 | Mar. 4, 2018 | .jpg | 377 | KB |
| software, APP | | | | | |
| Project 1, engineering, | fw1 | Mar. 7, 2018 | .doc | 90 | KB |
| software, FW | | | | | |
| Project 1, engineering, | fw2 | Mar. 7, 2018 | .doc | 125 | KB |
| software, FW | | | | | |
| Project 1, engineering, | fw3 | Mar. 9, 2018 | .doc | 320 | KB |
| software, FW | | | | | |
| Project 1, engineering, | p1B | Mar. 12, 2018 | .xls | 59 | KB |
| hardware, material list | | | | | |
| Project 1, engineering, | s | Mar. 12, 2018 | .xls | 79 | KB |
| hardware, PCB design, | | | | | |
| circuit diagram | | | | | |
| Project 1, engineering, | p | Mar. 14, 2018 | .xls | 105 | KB |
| hardware, PCB design, layout | | | | | |
| Project 1, engineering, | Test | Mar. 15, 2018 | .xls | 112 | KB |
| hardware, test | report | | | | |

With an aim of implementing precise target-file retrieval, when the retrieval instruction includes the tag “engineering” and a file name “Cell2”, the retrieval result is displayed in the file management interface as shown in Table 3. The interface only includes a target file containing both the tag “engineering” and the file name “Cell2”. The file name of the target file is Cell2.

TABLE 3

| | File | Modification | | |
|---|---|---|---|---|
| Tag | Name | Date | Type | Size |
| Project 1, engineering, | Cell2 | Mar. 5, 2018 | .doc | 116 KB |
| software, SW | | | | |

Accordingly, in embodiments of the present application, the correspondence between the FCB of the file and the file name and the correspondence between the FCB of the file and the tag are established for the file so that the file can be found rapidly through at least one of the file name or the tag, no longer needing to indexing a multi-level directory structure, implementing the flat management for the file, and improving the efficiency of file retrieval and addressing.

Embodiments of the present application further disclose a file system. On the basis of the preceding embodiments, the tag assignment module 2 is further configured to establish, according to the tag assignment instruction, the correspondence between the tag, which is in the tag library and corresponds to the tag assignment instruction, and the file name of the file corresponding to the tag assignment instruction.

When the first correspondence between the FCB of the file and the file name is established, the correspondence between the tag and the FCB of the file is no longer established while the second correspondence between the tag and the file name is established, thereby simplifying correspondence, effectively using the previously-established correspondence, and diversifying retrieval manners.

Such correspondence refers to the above-mentioned indirect correspondence between the tag and the FCB of the file.

The tag assignment module 2 is further configured to establish, according to the tag assignment instruction, the correspondence between the tag number of the tag corresponding to the tag assignment instruction in the tag library and the file name of the file corresponding to the tag assignment instruction. Each tag corresponds to one corresponding tag number.

In the file system provided in embodiments of the present application, the tag library includes not only tags but also tag numbers. The tags have a one-to-one correspondence with the tag numbers.

A tag itself usually has a large data size. For example, tag “engineering” in Chinese occupies four bytes, while tag number “1” only occupies one byte. The tag number instead of the tag is used for establishing the correspondence with the file name so as to indirectly establish the correspondence between the tag and the FCB of the file, implementing file retrieval by using the tag number, reducing the data size, and improving the retrieval speed.

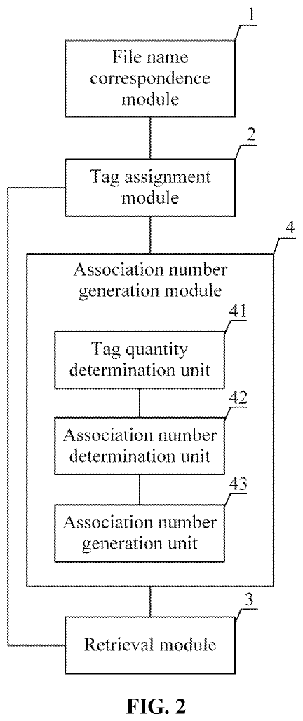

Embodiments of the present application further disclose a file system. Referring to FIG. 2, on the basis of the preceding embodiment, an association number generation module 4 is further included.

The association number generation module 4 is configured to generate an association number and establish the correspondence between a tag set and the association number. When the file corresponds to multiple tags, a set composed of the tags is referred to as a tag set.

The file system provided in embodiments of the present application further includes an association number library. Each association number corresponds to the tag set, the tag set corresponds to the file, and the association number library is stored in the external memory of the computer and is configured to store association numbers and the correspondence between the association number and the tag set corresponding to the file. In performing file retrieval, the system uses only the information table and does not need to use the association number library; accordingly, the association number library does not need to be read from the external memory into the internal memory. The system reads the association number library from the external memory into the internal memory only when receiving the user's request for such tasks as querying, searching for, displaying, newly adding, modifying, or deleting the association number in the association number library. The modified association number library in the internal memory is written back to the external memory in time.

With an aim of further speeding up retrieval and diversifying retrieval manners, an association number can be added for a file corresponding to multiple tags. It is to be understood that a file usually corresponds to multiple tags. In this case, when tags are used for narrowing the scope for file retrieval, the retrieval instruction needs to include multiple tags, making input cumbersome. Accordingly, an association number can be added. One association number may correspond to multiple tags. In this case, a target file corresponding to multiple tags can be found by inputting only a corresponding association number, further speeding up retrieval and improving user experience.

An association number can be considered as an upper-level tag of tags. According to the requirements of a practical application, multiple levels of tags can also be included to form a tag tree. For example, multiple association numbers correspond to one new tag so that the new tag serves as the upper-level tag of the association numbers. Alternatively, for a file already corresponding to multiple association numbers, an association number corresponding to an association number set including the association numbers can be set. Tags at each level speed up file retrieval.

When an association number is considered as a tag, the setting of the correspondence between the association number and the FCB of the file may be the same as the setting of the correspondence between a tag and the FCB of a file. The description of the embodiments in the present application is the same for a set of tags without an association number, the set itself can be considered as a special tag and can be set corresponding to the FCB of a file.

The retrieval module 3 is further configured to receive the retrieval instruction, retrieves the target file by using the retrieval instruction, at least one of the correspondence between the FCB of the file and an association number, the correspondence between the FCB of the file and the file name or the correspondence between the FCB of the file and the tag, and open and/or display the target file corresponding to the retrieval instruction.

It is to be noted that an upper-level tag can be set for an association number, which is similar to a tag. A multi-level relationship can also be formed for tags. A tag may have a corresponding child tag or parent tag so that the multiple levels of tags are formed or the tag tree is formed, which is set according to the requirements in a practical application.

It is to be understood that any file may correspond to a corresponding association number according to requirements. The generation of an association number has no specific restrictive condition. The file system in embodiments of the present application may generate an association number through the modules below.

The association number generation module 4 includes a tag quantity determination unit 41, an association number determination unit 42, and an association number generation unit 43.

The tag quantity determination unit 41 is configured to determine whether the quantity of tags corresponding to a file meets a quantity requirement.

After the file is assigned with a tag and before an association number is generated, it is determined whether the quantity of existing tags corresponding to the file meets the quantity requirement for setting an association number. When the file has only a small number of tags, it is determined that the quantity of the tags corresponding to the file does not meet the quantity requirement for setting an association number, and thus no association number is set for the file. When the file corresponds to a large number of tags, it is determined that the quantity of the tags corresponding to the file meets the quantity requirement for setting an association number, and thus an association number is set for the file.

Optionally, a tag quantity threshold may be set. When the quantity of the tags corresponding to the file is greater than or equal to the tag quantity threshold, it is determined that an association number is set for the file. When the quantity of the tags corresponding to the file is smaller than the tag quantity threshold, it is determined that no association number is set for the file.

The association number determination unit 42 is configured to, in the case where the tag quantity determination unit 41 determines that the quantity requirement of the tags is met, select part of the tags corresponding to the file according to a preset tag selection rule to form a tag set and determine whether the tag set has a corresponding association number.

When the quantity of the tags corresponding to the file meets the quantity requirement, part of the tags can be selected according to the preset tag selection rule to serve as one tag set. When the tag set has no corresponding association number, an association number is set for the tag set. When the tag set already has a corresponding association number, it is unnecessary to establish a new association number.

The tag selection rule may be that any two tags are selected from all the tags corresponding to the file to be taken as one tag set. Alternatively, the tag selection rule may be that three tags are selected from all the tags corresponding to the file to be taken as one tag set. Alternatively, all the tags are taken as one tag set. For example, the tag library includes five tags, “project”, “engineering”, “hardware”, “PCB design”, and “circuit diagram”. The tag selection rule may be that any two tags are selected from the five tags to be taken as one tag set; accordingly, tag sets including “project and engineering”, “hardware and PCB design”, “project and PCB design”, and “PCB design and circuit diagram” can be obtained. The tag selection rule may be that any three tags are selected from the five tags to be taken as one tag set; accordingly, tag sets including “project, engineering and hardware”, “engineering, hardware and PCB design”, “hardware, PCB design and circuit diagram”, and “project, PCB design and circuit diagram” can be obtained. The tag selection rule may also be that all the tags corresponding to the file are taken as one tag set; accordingly, a tag set “project, engineering, hardware, PCB design and circuit diagram” is obtained. The specific tag selection rule is not limited here, and an operator can perform the setting flexibly according to requirements.

The association number generation unit 43 is configured to, in the case where the association number determination unit 42 determines that the tag set has no corresponding association number, newly generate an association number and establish the correspondence between the tag set and the newly-generated association number.

When the selected tag set has no corresponding association number, an association number is newly generated to correspond to the tag set, and the correspondence between the tag set and the newly-generated association number is established. Each association number corresponds to a unique tag set so that target files can be filtered by using association numbers.

The newly-generated association number and a content of the newly-generated association number are stored in the association number library and may be applied to the file in the information table. The content of the newly-generated association number is the tag set of the file. The tag set includes one or more tags.

For example, on the basis of the preceding Table 1, association numbers are newly added in the information table. Part of the information in the newly-added information table is shown in Table 4. The FCB of the file in each row includes the file name, the tags, the association number and the physical address of the file.

As shown in Table 4, the tag selection rule is that all the tags corresponding to each file are taken as one tag set for which the association number is set. For example, the file with the file name “cell1” corresponds to four tags, and the association number corresponding to the file is g1.

Additionally, after the correspondence between a tag set and an association number is established, the tag column may be deleted after the association number column is newly added in the information table. Although the information table no longer stores tags corresponding to a file, the user can still query the file through the tag. When the user inputs one or more tags corresponding to a target file, the operating system finds, according to the correspondence between an association number and the tag set in the association number library, the association number corresponding to the input one or more tags so that the FCB of the file corresponding to the association number is determined, and thus the target file is determined through the physical address in the FCB.

TABLE 4

| | | Association | Physical |
|---|---|---|---|
| File Name | Tag | Number | Address |
| Cell1 | Project 1, engineering, | g1 | 4 |
| | software, SW | | |
| Cell2 | Project 1, engineering, | g1 | 5 |
| | software, SW | | |
| Af1 | Project 1, engineering, | g2 | 6 |
| | software, APP | | |
| Af2 | Project 1, engineering, | g2 | 7 |
| | software, APP | | |
| fw1 | Project 1, engineering, | g3 | 8 |
| | software, FW | | |
| fw2 | Project 1, engineering, | g3 | 9 |
| | software, FW | | |
| fw3 | Project 1, engineering, | g3 | 10 |
| | software, FW | | |
| p1B | Project 1, engineering, | g4 | 11 |
| | hardware, material list | | |
| p1B | Project 1, production, | g5 | 12 |
| | material list | | |
| Plan 1 | Project 1, management, plan | g6 | 13 |
| Cost 1 | Project 1, management, cost | g7 | 14 |
| s | Project 1, engineering, | g8 | 15 |
| | hardware, PCB design, | | |
| | circuit diagram | | |
| p | Project 1, engineering, | g9 | 16 |
| | hardware, PCB design, layout | | |
| Test report | Project 1, engineering, | g10 | 17 |
| | hardware, test | | |

It is to be understood that an association number is not necessarily in the expression form of numerals or any combination of letters and numerals but may also be represented in words. For example, association number “g3” in Table 4 may also be represented in words “third association number”.

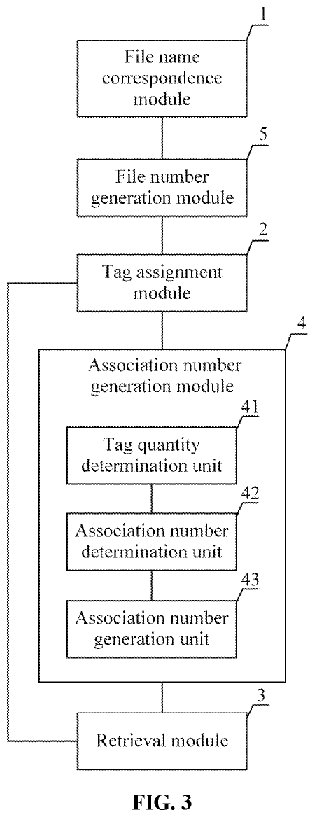

Embodiments of the present application further disclose a file system. Referring to FIG. 3, to further improve the convenience of file management and distinction, the system also includes a file number generation module 5.

The file number generation module 5 is configured to generate a file number, establish the correspondence between the file number and the FCB of the file, and store the file number and the correspondence between the file number and the FCB of the file in the information table.

The file system provided in embodiments of the present application further includes a file number library. The file number library is configured to store file numbers.

The file number generation module 5 is further configured to establish the correspondence between the file number and the file name of the file. For example, the file number library is included in the file name library, and file numbers have a one-to-one correspondence with file names.

Because a file name is relatively long, the data size for indexing the file by using the file name is large. Accordingly, to help with indexing the file, a file number with a smaller data size is generated so that the file can be indexed using the file number through establishing the correspondence between the file number and the file name or the correspondence between the file number and the FCB of the file, reducing the data size of indexing the file. Additionally, compared with the file name, the file number is shorter and easier to remember, which is convenient for the user to use file numbers to search for, in particular, multiple files. For example, ten files created in sequence for the same project are pre-stored in the file library. If the files are searched for by using file names, the file name of each file needs to be remembered, resulting in an excessively high requirement for memory and poor user experience. The situation is different when file numbers exist. For example, the file number of the file first created among the ten files is 5. Since the files are created in sequence, the file numbers are continuous. Accordingly, the file numbers of the ten files are sequentially from 5 to 14. The ten files can be found through file numbers 5 to 14, which is more convenient and rapid.

On the basis of the preceding Table 4, file numbers are newly added in the information table. Part of the information in the newly-added information table is shown in Table 5. The FCB of the file in each row includes the file name, file number, tags, association number and physical address of the file.

Additionally, after the correspondence between the file name and the file number is established, the file name column may be deleted after the file numbers are newly added in the information table. Although the information table no longer stores the file name of the file, the user can still query the file through the file name. When the user inputs the file name of a target file, the operating system, according to the correspondence between the file name and a file number in the file name library which includes the file number library, finds the file number corresponding to the input file name so that the FCB of the file corresponding to the file number is determined, and thus the target file is determined through the physical address in the FCB.

TABLE 5

| File | File | | Association | Physical |
|---|---|---|---|---|
| Name | Number | Tag | Number | Address |
| Cell1 | f1 | Project 1, engineering, | g1 | 4 |
| | | software, SW | | |
| Cell2 | f2 | Project 1, engineering, | g1 | 5 |
| | | software, SW | | |
| Af1 | f3 | Project 1, engineering, | g2 | 6 |
| | | software, APP | | |
| Af2 | f4 | Project 1, engineering, | g2 | 7 |
| | | software, APP | | |
| fw1 | f5 | Project 1, engineering, | g3 | 8 |
| | | software, FW | | |
| fw2 | f6 | Project 1, engineering, | g3 | 9 |
| | | software, FW | | |
| fw3 | f7 | Project 1, engineering, | g3 | 10 |
| | | software, FW | | |
| p1B | f8 | Project 1, engineering, | g4 | 11 |
| | | hardware, material list | | |
| p1B | f8 | Project 1, production, | g5 | 12 |
| | | material list | | |
| Plan 1 | f9 | Project 1, management, plan | g6 | 13 |
| Cost 1 | f10 | Project 1, management, cost | g7 | 14 |
| s | f11 | Project 1, engineering, | g8 | 15 |
| | | hardware, PCB design, | | |
| | | circuit diagram | | |
| p | f12 | Project 1, engineering, | g9 | 16 |
| | | hardware, PCB design, layout | | |
| Test | f13 | Project 1, engineering, | g10 | 17 |
| report | | hardware, test | | |

In the preceding embodiments, the correspondence between the file name and the FCB of the file refers to that the FCB of the file includes the file name, and the correspondence of the tag and the FCB of the file refers to that the FCB of the file includes the tag. Additionally, the correspondence between the FCB of the file and the file name and the correspondence between the FCB of the file and the tag may be established through mapping.

On the basis of the preceding embodiments, when the correspondence between the FCB of the file and the file name and the correspondence between the FCB of the file and the tag are established through mapping, part of the information in the information table generated by the operating system is shown in Table 6. In Table 6, each row of information in the information table includes the file name, file number, FCB, tags and association number of the file. The FCB of the file includes the physical address of the file.

In Table 6, since file names usually have a one-to-one correspondence with the file numbers, one of the file name column or the file number column may be deleted. If not completely required, one of the tag column or the association number column may also be deleted to save the space of the information table.

TABLE 6

| File | File | | | Association |
|---|---|---|---|---|
| Name | Number | FCB | Tag | Number |
| Cell1 | f1 | f1_fcb | Project 1, engineering, | g1 |
| | | | software, SW | |
| Cell2 | f2 | f2_fcb | Project 1, engineering, | g1 |
| | | | software, SW | |
| Af1 | f3 | f3_fcb | Project 1, engineering, | g2 |
| | | | software, APP | |
| Af2 | f4 | f4_fcb | Project 1, engineering, | g2 |
| | | | software, APP | |
| fw1 | f5 | f5_fcb | Project 1, engineering, | g3 |
| | | | software, FW | |
| fw2 | f6 | f6_fcb | Project 1, engineering, | g3 |
| | | | software, FW | |
| fw3 | f7 | f7_fcb | Project 1, engineering, | g3 |
| | | | software, FW | |
| p1B | f8 | f8_fcb | Project 1, engineering, | g4 |
| | | | hardware, material list | |
| p1B | f8 | f9_fcb | Project 1, production, | g5 |
| | | | material list | |
| Plan 1 | f9 | f10_fcb | Project 1, management, plan | g6 |
| Cost 1 | f10 | f11_fcb | Project 1, management, cost | g7 |
| s | f11 | f12_fcb | Project 1, engineering, | g8 |
| | | | hardware, PCB design, | |
| | | | circuit diagram | |
| p | f12 | f13_fcb | Project 1, engineering, | g9 |
| | | | hardware, PCB design, layout | |
| Test | f13 | f14_fcb | Project 1, engineering, | g10 |
| report | | | hardware, test | |

The implementation of Table 6 is similar to the FCB decomposition method of Unix in the related art. In Unix, an FCB is decomposed into a directory entry and an inode. The directory entry includes a file name and a pointer pointing to the inode. In comparison, in the solution of Table 6, a combination of a file name and tags is equivalent to a file name in Unix. An FCB file in the FCB column in Table 6 is equivalent to an inode or an inode pointer in Unix. When the FCB column stores the entire content of the FCB file, the FCB file is equivalent to an inode in Unix. In this case, a pointer pointing to the inode is not needed because all the information in the FCB file directly corresponds to the combination of the file name and the tags. When the FCB column cannot store the entire content of the FCB file, the content of the FCB file must be stored elsewhere as a separate file, and this file is equivalent to an inode in Unix. In this case, pointers pointing to such files can be placed in the FCB column of Table 6. These pointers are equivalent to inode pointers in Unix. Of course, in a combination of the file name and one or more tags here, the file name may be replaced by the file number, and the tags may be replaced by tag numbers corresponding to the tags or an association number corresponding to the tags.

The input information on retrieving a file in Unix refers to a path containing a file name. Accordingly, an inode may store the information of a subdirectory. The physical address of a file can be obtained only by finding the last level of the path. What is different from Unix is that in the solution of Table 6, the physical address of the file can be obtained directly with no subdirectory information included in an inode.

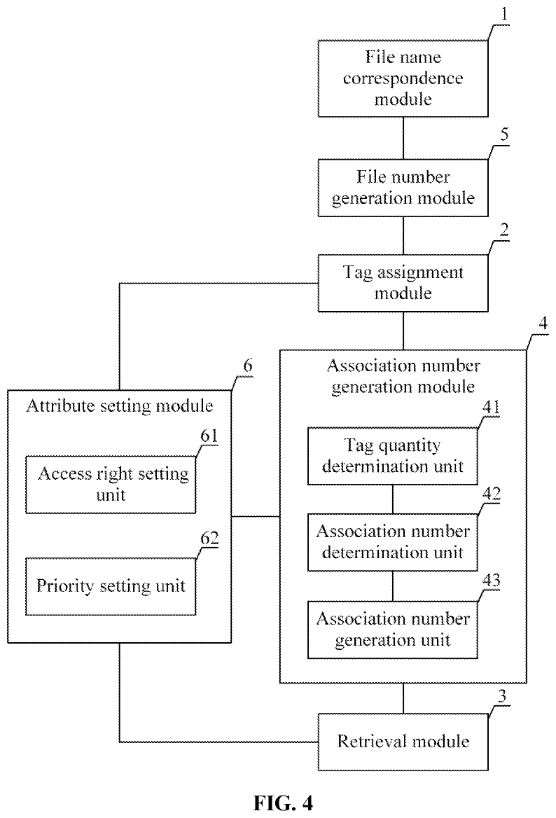

On the basis of the preceding embodiments, embodiments of the present application further disclose a file system as shown in FIG. 4. To further enrich the function of the tag and the association number, a corresponding attribute can be further added to the tag and/or the association number. Accordingly, an attribute setting module is configured to establish the correspondence between a preset attribute and the association number and/or the correspondence between the preset attribute and the tag. The function of the association number and/or tag can be enriched by establishing at least one of the correspondence between a preset attribute and the association number or the correspondence between the preset attribute and the tag. For example, the attribute may be an access right or a priority.

Files that can be accessed by different users are different. Accordingly, access rights can be set for different users. For example, a user A can only read a file A but cannot rewrite the file A, and a user B can read and rewrite the file A.

An access right may be set in the form of a tag and/or an association number. Accordingly, the attribute setting module 6 includes an access right setting unit 61 configured to establish at least one of the correspondence between a preset access right and the tag or the correspondence between the preset access right and the association number. For example, the file A can be accessed only by the user A. Then the tag “user A” is assigned to the file A. The tag corresponds to the preset access right so that the file A can be accessed only by the user A but cannot be accessed by other users. Similarly, an association number can also be set in the same way. For example, the file A can be accessed only by the user A. Then the association number “user A” is assigned to the file A. The association number corresponds to the preset access right. The expression manner of at least one of the tag having an access right attribute or the association number having an access right attribute is not limited being represented in above words and can be set according to user requirements.

To further improve user experience in file retrieval, the attribute setting module 6 may further include a priority setting unit 62.

The priority setting unit 62 is configured to set at least one of the priority of the association number or the priority of the tag.

The retrieval module 3 is further configured to receive the retrieval instruction; find, according to the retrieval instruction, the target file corresponding to the retrieval instruction by using at least one of the correspondence between the FCB of the file and the file name or the correspondence between the FCB of the file and the tag; and display the target file in sequence by using at least one of the priority of the association number or the priority of the tag.

When multiple tags are retrieved, with an aim of classifying multiple files, at least one of a priority for a tag or a priority for an association number corresponding to each file may be preset. A file corresponding to a tag and/or an association number with a higher priority is displayed preferentially so that the user can view the file first. A file corresponding to a tag and/or an association number with a lower priority is displayed after the file having the tag and/or the association number with the higher priority. Accordingly, the files are classified according to their priorities so that the user can find a corresponding file more quickly, further facilitating file searching.

Table 7 is a diagram illustrating the structure of a multi-level directory structure in the related art. The directory system is a three-level directory; that is, the directory structure includes a root directory, first-level subdirectories (the directory of U1, the directory of U2, the directory of U3, and the directory of U4) and a second-level subdirectory (the directory of sub).

Exemplarily, in the directory of U1, the file name of the FCB in the first row is aa, and the physical address of the FCB in the first row is 7. In the directory of U2, the file name of the FCB in the first row is also aa, and the physical address of the FCB in the first row is also 7. Accordingly, the file corresponding to the FCB in the first row of U1 and the file corresponding to the FCB in the first row of U2 are the same file. U1 \aa represents the absolute physical address of the file aa and U2\aa represents a link of the file aa. The file name corresponding to the FCB in the second row of U2 is cc, and the physical address corresponding to the FCB in the second row of U2 is 9. The physical address of the FCB in the second row of U4 points to the second-level subdirectory (the directory of sub). The file name corresponding to the FCB of sub is also cc, and the physical address corresponding to the FCB of sub is 9. Accordingly, the file corresponding to the FCB in the second row of U2 and the file corresponding to the FCB in sub of U4 are the same file. U4\sub\cc represents the absolute physical address of the file cc and U2\cc represents a link of the file cc.

For example, when using the multi-level directory structure to retrieve the file whose file name is cc, after receiving the absolute physical address U4\sub\cc which is input by the user, the operating system first finds, from the root directory read into the internal memory at booting up that the physical address of U4 is 6, then finds the directory of U4 according to the physical address, and finally reads the directory of U4 from the external memory into the internal memory. Moreover, the operating system finds from the directory of U4 that the physical address of sub is 13, finds the directory of sub according to the physical address, and reads the directory of sub from the external memory into the internal memory. Finally, the operating system finds from the directory of sub that the physical address of file name cc is 9 and reads the target file from external memory into the internal memory according to the physical address.

The operation of disk I/O reading is performed three times in this query process so the efficiency of file retrieval is very low.

In the file system in embodiments of the present application, multi-level directories are no longer used for retrieving a file. Instead, the correspondence between the FCB and the file name and the correspondence between the FCB and the tag are established; moreover, the correspondences are reflected in one information table. The information table helps implement the flat management for the file, and the concept of a file path no longer exists. In the other hand, the flat management for the file shows all different files with the same file name to the user in one table (which is named the information table), so there is no need for the user to open every file across all the directories where the file with the same file name is located when the user wants to find the right file. Accordingly, retrieval efficiency is improved. In particular, when multiple users share a file in the related art, the multiple users have to be informed of the file name with the file path. However, in the present application, the file name with the file path can be replaced with the combination of a tag and the file name, the multiple users may share the file with the combination of the file name and the tag.

In combination with the preceding Table 7, the information table of the present application is shown in Table 8, and the tag library and the association number library are shown in Table 9. Exemplarily, each row in Table 8 represents the FCB of one file. The file name of the FCB in the first row is aa, and tags of the FCB in the first row are U1 and U2. Since the file corresponds to multiple tags, association number ml is set for the file. The file name of the FCB in the second row is bb, and the tag of the FCB in the second row is U1. Since the file only corresponds to one tag, no association number is set for the file.

For example, when the information table is used for retrieving a file whose name is cc, the user inputs file name cc. Then it is directly determined from the information table that the physical address of file name cc is 9. According to the physical address, the target file is read from the external memory into the internal memory.

The operation of disk I/O reading is performed only once in this query process, greatly improving the efficiency of file retrieval.

TABLE 8

| | | | Association | Physical |
|---|---|---|---|---|
| File Name | File Number | Tag | Number | Address |
| aa | 1 | U1, U2 | m1 | 7 |
| bb | 2 | U1 | | 8 |
| cc | 3 | U2, U4, sub | m2 | 9 |
| dd | 4 | U3 | | 10 |
| ee | 5 | U3 | | 11 |
| ff | 6 | U4 | | 12 |

Additionally, it can be seen from the preceding Table 8 that the information table further includes file numbers, tags, and association numbers. Apart from using a file name to retrieve a file, the user may also retrieve the file in any combination of a file name, a file number, a tag, a tag number and an association number. In this case, file retrieval manners are diversified, and retrieval precision is enhanced.

Generally, file numbers correspond to file names, and tags correspond to association numbers. Accordingly, the information table may also include only one of a file number or a file name and only one of a tag or an association number to reduce the storage space requirement of the information table.

In particular, when the tags U1, U2, U3 and U4 in Table 8 represent four users respectively, each of them may be set to correspond to a corresponding access right attribute. For example, the file aa may only be accessed by the users U1 and U2, and the file bb may only be accessed by the user U1.

As mentioned above, in the file system in embodiments of the present application, the correspondence between a file name and the FCB of a file is extended from current multi-level directory structures. Additionally, the correspondence between a tag and the FCB of a file is also established. The method for establishing the correspondence between the tag and the FCB of the file includes the operations below.

In step 1, the correspondence between the file name and the FCB of the file is established.

In step 2, a tag assignment instruction is received, and it is queried in the tag library of the file system whether a tag corresponding to the tag assignment instruction exists. If the tag exists, step 3 is performed; otherwise, step 4 is performed.

In the file system, the FCB of the file may correspond to multiple tags. Accordingly, one or more tags may correspond to the instruction.

The tag corresponding to the tag assignment instruction may refer to a tag carried in the tag assignment instruction.

In step 3, it is checked in the information table whether the combination of the file name and the tag already exists. If the combination already exists, at least one of the file name or the tag is prompted to be changed, and the steps 1 to 3 are repeated until the combination of the file name and the tag does not exist, then step 5 is performed. If the combination does not exist, step 5 is performed.

In step 4, a tag corresponding to the tag assignment instruction is newly added in the tag library.

In step 5, the correspondence between the tag corresponding to the tag assignment instruction and the FCB of the file corresponding to the tag assignment instruction is established, and the correspondence and the combination of the tag and the file name are stored in the information table.

In the file system, the correspondence between an association number and the FCB of a file may also be established, which includes the operations below.

In step 1, a tag assignment instruction is received, and it is determined whether the quantity of tags corresponding to the file which corresponds to the tag assignment instruction meets the quantity requirement in the tag quantity determination unit 41. If the quantity requirement is met, step 2 is performed. If the quantity requirement is not met, the process ends.

Optionally, a tag quantity threshold may be set. When the quantity of the tags corresponding to the file is greater than or equal to the tag quantity threshold, it is determined that an association number is set for the file. When the quantity of the tags corresponding to the file is smaller than the tag quantity threshold, it is determined that no association number is set for the file.

In step 2, it is determined whether an association number library exists in the file system. If an association number library exists, step 3 is performed. If no association number library exists, step 4 is performed.

The association number library is configured to store combinations of multiple tags. When the FCB of the file corresponds to multiple tags, the tags correspond to one association number. The file system establishes the correspondence between the association number and the FCB of the file and stores the tags as the content of the association number in the association number library. Details are listed in Table 9 below.

TABLE 9
Tag library

| Tag | Tag Number |
|---|---|
| U1 | 1 |
| U2 | 2 |
| U3 | 3 |
| U4 | 4 |
| sub | 5 |

Association
Number library

| Association | |
|---|---|
| Number | Content |
| m1 | U1, U2 |
| m2 | U2, U4, sub |

In step 3, it is checked whether the content of the existing association number in the association number library includes a tag set composed of the tags. If included, step 6 is performed, and if not included, step 5 is performed.

In step 4, an association number library is newly created, and an association number is newly established in the newly-created association number library, where the content of the association number is the tag set. Step 6 is then performed.

In step 5, an association number is newly established in the association number library, where the content of the association number is the tag set.

In step 6, it is first checked whether the association number has been applied to the file in the information table, if the association number has been applied to the file in the information table, it is next checked whether the combination of the file name and the association number already exists. If the association number is not applied to the file in the information table, applying of the association number to the file in the information table is performed and it is then checked whether the combination of the file name and the association number already exists.

In step 7, if the combination of the file name and the association number already exists, at least one of the file name or the association number is prompted to be changed, operations in steps 3, 5, 6 and 7 are repeated until the combination of the file name and the association number does not exist, and step 8 is then performed. If the combination of the file name and the association number does not exist, step 8 is performed.

In step 8, the correspondence between the association number and the FCB of the file is established, and the correspondence and the combination of the association number and the file name are stored in the information table.

After a file is found, the file may be opened and/or displayed. The opened file may be edited or operated in the same way as the related art.

Finally, it should also be noted that in this article, relationship terms such as a first and a second are used merely to distinguish one entity or operation from another. It does not necessarily require or imply any such actual relationship or order between these entities or operations. Furthermore, the term “comprising”, “including” or any other variant thereof is intended to encompass a non-exclusive inclusion so that a process, method, article or device that includes a series of elements not only includes the expressly listed elements but may also include other elements that are not expressly listed or are inherent to such process, method, article or device. In the absence of more restrictions, the elements defined by the statement “including a . . . ” do not exclude the presence of additional identical elements in the process, method, article or device that includes the elements.

Those skilled in the art should be further aware that, the units and algorithm steps of the examples described in conjunction with the embodiments disclosed herein can be implemented in electronic hardware, computer software, or a combination thereof. In order to clearly illustrate the interchangeability of hardware and software, the composition and steps of the examples have been described generally in terms of functionality in the foregoing description. Whether these functions are performed in hardware or software depends on the specific application and design constraints of the technical solution. Those skilled in the art may use different methods to implement the described functions for each specific application, but such implementation should not be considered to be beyond the scope of embodiments of the present application.

The above describes the technical content provided in embodiments of the present application in detail. The principles and implementations of embodiments of the present application are described herein with specific examples. The preceding description of the embodiments is merely for assisting in understanding the method of embodiments of the present application and its core ideas. At the same time, for those of ordinary skill in the art, according to the idea of embodiments of the present application, there will be changes in specific implementations and applications. In summary, the content of this specification should not be construed as limiting embodiments of the present application.

What is claimed is:

1. A file system, applied to a file library without a directory structure, comprising:
a file name correspondence module configured to establish a correspondence between a file name of a file and a file control block (FCB) of the file and store the file name and the correspondence between the file name and the FCB of the file in an information table, wherein the information table comprises at least one row of information, and each row of information among the at least one row of information represents descriptive information of one file;
a tag assignment module configured to establish, according to a tag assignment instruction, a correspondence between a tag, which is in a tag library and corresponds to the tag assignment instruction, and the FCB of the file corresponding to the tag assignment instruction, and store the tag and the correspondence between the tag and the FCB of the file in the information table, wherein the file system comprises the tag library, and the tag library pre-stores at least one tag; and
a retrieval module configured to receive a retrieval instruction; find, according to the retrieval instruction, a target file corresponding to the retrieval instruction in the information table and the file library by using at least one of the correspondence between the file name and the FCB of the file or the correspondence between the tag and the FCB of the file; and open and/or display the target file;
wherein the retrieval instruction comprises at least one of the file name of the target file or the tag corresponding to the target file.

2. The file system according to claim 1, wherein the file name correspondence module establishes the correspondence between the file name of the file and the FCB of the file in one of the following manners:
comprising the file name of the file in the FCB of the file; or
establishing a mapping relationship between the file name of the file and the FCB of the file.

3. The file system according to claim 2, wherein the tag assignment module establishes a correspondence between the tag corresponding to the file and the FCB of the file in one of the following manners:
comprising the tag in the FCB of the file; or
establishing a mapping relationship between the tag and the FCB of the file.

4. The file system according to claim 3, wherein in a case where the FCB of the file comprises the file name of the file and the tag corresponding to the file, each row in the information table represents an FCB of the file, and the FCB of the file comprises the file name of the file, the tag corresponding to the file, and a physical address of the file.

5. The file system according to claim 3, wherein in a case where the mapping relationship between the file name of the file and the FCB of the file exists and the mapping relationship between the tag corresponding to the file and the FCB of the file exists, each row in the information table comprises the FCB of the file, the file name of the file, and the tag corresponding to the file.

6. The file system according to claim 1, wherein the tag assignment module establishes the correspondence between the tag corresponding to the file and the FCB of the file by performing the following operations:
according to the tag assignment instruction, querying in the tag library in the file system whether the tag corresponding to the tag assignment instruction exists;
in a case where the tag corresponding to the tag assignment instruction exists in the tag library, checking in the information table whether a combination of the file name and the tag already exists; and
in a case where it is checked in the information table that the combination of the file name and the tag does not exist, establishing the correspondence between the tag corresponding to the tag assignment instruction and the FCB of the file corresponding to the tag assignment instruction, and storing the correspondence and the combination of the file name and the tag in the information table.

7. The file system according to claim 6, wherein in a case where no tag corresponding to the tag assignment instruction exists in the tag library, a tag is newly added in the tag library, a correspondence between the newly-added tag and the FCB of the file corresponding to the tag assignment instruction is established, and the correspondence and the combination of the tag and the file name are stored in the information table.

8. The file system according to claim 6, wherein in a case where it is checked that the combination of the file name and the tag already exists in the information table, at least one of the file name or the tag is prompted to be changed until the combination of the file name and the tag does not exist.

9. The file system according to claim 1, wherein
the file system further comprises a file name library configured to store the file name; or
the file name is taken as a special tag to be stored in the tag library.

10. The file system according to claim 1, wherein the tag assignment module is specifically configured to establish, according to the tag assignment instruction, a correspondence between the file name of the file and the tag which is in the tag library and corresponds to the tag assignment instruction.

11. The file system according to claim 1, wherein the tag library further stores at least one tag number, and the at least one tag has a one-to-one correspondence with the at least one tag number;
the tag assignment module is further configured to establish, according to the tag assignment instruction, a correspondence between a tag number of the tag, which is in the tag library and corresponds to the tag assignment instruction, and the file name of the file; and store the tag number and the correspondence between the tag number and the file name of the file in the information table; and
the retrieval module is further configured to receive the retrieval instruction; find, according to the retrieval instruction, the target file corresponding to the retrieval instruction by using at least one of the tag number, the correspondence between the file name and the FCB of the file, or the correspondence between the tag and the FCB of the file; and open and/or display the target file.

12. The file system according to claim 1, further comprising:
an association number generation module configured to generate an association number and establish a correspondence between a tag set and the association number, wherein the tag set comprises one or more tags corresponding to the file, the file system further comprises an association number library which is configured to store the association number and the correspondence between the tag set and the association number, wherein the association number and the correspondence between the tag set and the association number is applied to the file in the information table;
wherein the retrieval module is further configured to receive the retrieval instruction and open and/or display, according to the retrieval instruction, the target file corresponding to the retrieval instruction by using at least one of the association number, the correspondence between the file name and the FCB of the file, or the correspondence between the tag and the FCB of the file.

13. The file system according to claim 12, wherein the association number generation module comprises:
a tag quantity determination unit configured to determine whether the quantity of tags corresponding to the file meets a quantity requirement;
an association number determination unit configured to, in a case where the tag quantity determination unit determines that the quantity of tags corresponding to the file meets a quantity requirement, determine whether the tag set selected from the plurality of tags corresponding to the file according to a preset tag selection rule has a corresponding association number; and
an association number generation unit configured to, in a case where the association number determination unit determines that the tag set has no corresponding association number, newly generate an association number, establish a correspondence between the tag set and the newly-generated association number, store the association number and the correspondence between the tag set and the newly-generated association number in the association number library, and apply the association number and the correspondence between the tag set and the newly-generated association number to the file in the information table.

14. The file system according to claim 1, further comprising:
a file number generation module configured to generate a file number, establish a correspondence between the file number and the FCB of the file, and store the file number and the correspondence between the file number and the FCB of the file in the information table, wherein the file system further comprises a file number library, and the file number library is configured to store the file number;
wherein the retrieval module is further configured to receive the retrieval instruction; find, according to the retrieval instruction, the target file corresponding to the retrieval instruction by using at least one of the file number, the correspondence between the file name and the FCB of the file, or the correspondence between the tag and the FCB of the file.

15. The file system according to claim 14, wherein the file number generation module is further configured to establish a correspondence between the file number and the file name of the file.

16. The file system according to claim 12, further comprising:
an attribute setting module configured to establish at least one of a correspondence between a preset attribute and the association number or a correspondence between a preset attribute and the tag.

17. The file system according to claim 1, further comprising:
an association number generation module configured to generate an association number and establish a correspondence between a tag set and the association number, wherein the tag set comprises one or more tags corresponding to the file; and
an attribute setting module configured to establish at least one of a correspondence between a preset attribute and the association number or a correspondence between a preset attribute and the tag.

18. The file system according to claim 16, wherein the attribute setting module comprises:
an access right setting unit configured to establish at least one of a correspondence between a preset access right and the association number or a correspondence between a preset access right and the tag.

19. The file system according to claim 16, wherein the attribute setting module comprises:
a priority setting unit configured to set at least one of a priority of the association number or a priority of the tag;
wherein the retrieval module is further configured to receive the retrieval instruction; find, according to the retrieval instruction, the target file corresponding to the retrieval instruction by using at least one of the correspondence between the FCB of the file and the file name or the correspondence between the FCB of the file and the tag; and display the target file in sequence by using at least one of the priority of the association number or the priority of the tag.
